(19) United States
(12) Patent Application Publication
(10) Pub. No.: US 2021/0126915 A1
(43) Pub. Date: Apr. 29, 2021

(54) DEVICE AND SYSTEM FOR SCREEN SHARING

(71) Applicant: KLIK Communications Inc., Bellevue, WA (US)

(72) Inventors: Constantin Lakoumentas, Bellevue, WA (US); Gabriel Ratener, Bellevue, WA (US)

(21) Appl. No.: 17/080,638

(22) Filed: Oct. 26, 2020

Related U.S. Application Data
(60) Provisional application No. 62/925,465, filed on Oct. 24, 2019.

(51) Int. Cl. H04L 29/06; G06F 3/14; H04L 29/08

(52) U.S. Cl. CPC H04L 63/0876; G06F 3/1454; H04L 63/083; H04L 67/104; H04L 65/4015; H04L 65/1069

(57) ABSTRACT

A device and system for screen sharing, referred to as KLIK Boks KORE, is an integrated hardware/software solution for collaboration that allows users to share content from any device to a central screen and in turn back to other users' screens for remote viewing of the content. Content displayed on the central screen is tiled in a grid by default, but may be resized, moved and overlaid in any arrangement by a meeting moderator, either by mouse or touch display control. Content may be annotated by those sharing, or by the moderator, directly over each tile, or across the entire screen surface.

### RELATED APPLICATIONS

This application claims the benefit of U.S. Provisional Patent Application No. 62/925,465, filed on Oct. 24, 2019, entitled “DEVICE AND SYSTEM FOR SCREEN SHARING,” which is hereby incorporated by reference in its entirety as if it were fully set forth herein.

### TECHNICAL FIELD

This disclosure relates generally to screen sharing between a plurality of computing devices and a centralized video display, and the retransmission of the composite of all shared screens to a plurality of viewers, without the need for download and installation of a specific software application. More specifically, the disclosure relates to many-to-many screen sharing, across the Internet, using only a web browser, and including specific collaboration features that aid in the sharing of information.

### BACKGROUND

Screen sharing between computing devices has been well established for nearly two decades in various applications, from remote technical support to meeting collaboration. The benefits of screen sharing are generally that the remote party is afforded the opportunity to view the content hosted on the presenter's computing device. This is generally the case when screen sharing is embodied in remote control applications or as a component of video conferencing systems and applications.

More recently, screen sharing has been popularized as a tool in meeting rooms and classrooms to facilitate collaboration and information exchange, between presenters and viewers of the content. Myriad devices are available commercially to support such screen sharing, each generally using one of three fundamental designs: Hardware-based systems, Software-based systems, and Hybrid systems.

In the case of Hardware-based systems, there exists one piece of hardware generally referred to as the receiver, which connects to a video display. A second hardware component, the transmitter, connects to a computing device either by a video cable or by a data connection; most often a serial data connection. In the latter case, the transmitter presents to the computing device as an external display, and thereby receives a facsimile of the display content for transmission to the receiver.

In the case of Software-based systems, no additional hardware is required between two computing devices. A software application loaded on the presenting device will capture the screen's contents and route that content over a local area network (LAN) to the receiving device. A software application running on the receiving device will receive the transmission and render the data into a video stream that may be viewed on any connected display.

Hybrid systems rely on one hardware appliance connected to the video display as the receiver but employ software on the presenter's computing device to act as the transmitter. In this system, the software application intercepts the data stream that is generating the video signal on the presenter's computing device, then routes it to the receiver over the local area network (LAN), where it is rendered into video, and sent to the video display for viewing.

Most recently, several applications and services have begun offering screen sharing as an adjunct to web-based video conferencing and communications systems. Such systems are designed to facilitate audio-visual communication between participants across different physical locations, and generally include video cameras and microphones to facilitate communication. Screen sharing and other features are supported, as part of a software application that users must download and install on their computing device.

Despite the array of present solutions, users and administrators of such systems remain dissatisfied with all of them, for a variety of reasons. In the case of hardware systems, the requirement for a physical connection to the computing device on the transmission end makes it virtually impossible to maintain broad device compatibility, as there are now many different video and data connector styles to contend with. Further, because such systems employ a transmitter and a receiver, their range is limited.

Software systems have proven problematic because they require that the computing device acting as the receiver be dedicated to that function alone, whenever a screen sharing session is hosted. In addition, the installation and configuration of software, along with the task of managing licenses and costs, make such systems difficult to maintain.

Hybrid systems simplify the deployment and maintenance aspects of dedicated screen sharing systems, but they also require the download and installation of a software application on the presenter's computing device. Also, because they use the local area network to route data between the presenter's device and the receiver, network design plays a large role in their deployment. With segregated virtual local area networks, and firewalls in the way, the essential network discovery protocols on which such system rely may be rendered unusable.

While the screen sharing applications bundled with video conferencing and communications systems offer the appeal of zero hardware and Internet connectivity, they fall short on several other important features that users and administrators are looking for. They require the installation of a computing platform specific application, and ultimately a computer dedicated to the screen sharing application when a session is being hosted.

The fundamental issues facing adopters of current screen sharing solutions range from the requirement for a dedicated software application to be installed on the client's computing device, to the complexity of deployment across an existing local area network that may consist of multiple, air-gapped, virtual local area networks. Further complicating adoption are the relative complexity of installation, configuration and deployment, and the burden they place on the clients. Most all current solutions impede users' established workflows, rather than integrate with them.

### SUMMARY

Various systems and embodiments discussed herein relate to facilitating connections between a plurality of computing devices. In an embodiment, systems may comprise a remote server configured to authenticate and manage connections between computing devices, a visual interface for displaying shared content over a web browser, and a hardware appliance in network communication with the remote server, the hardware appliance comprising a processor and a memory having instructions stored thereon to execute a software application. The software application can cause the hardware appliance to receive a request from a first computing device to initiate a meeting to display shared content; establish a secure connection with the remote server; generate a unique internet address through which to display shared content; receive an indication of a request at the unique internet address, from a second computing device, to join the meeting, wherein the request includes credentials from the second device; authenticate the credentials at the remote server; and display shared content via the visual interface, on the first computing device and the second computing device.

In an embodiment, the hardware appliance may further be configured to receive content from each computing device at the meeting, e.g., audio and visual content, compile the content from each computing device into a composite view comprising thumbnails displaying content from each computing device; and display the composite view on a display of each computing device. Content may comprise a live video, a screen share, image, and input from a peripheral device, such as a microphone, a video camera, a document camera, and an audio output.

In one aspect, the invention features a method for many-to-many screen sharing by using only a common browser, without requiring the download and installation of a software application. Accordingly, embodiments of the invention can feature a method for facilitating a peer-to-peer connection between a computing device and a second computing device, for the purpose of screen sharing, through a server accessible through the Internet. This method need not rely on the common forms of network discovery and is therefore not subject to limitations in traversal of network address translation, virtual local area networks.

In another aspect, the invention features a method for capturing the screen contents of the presenter's computing device. Embodiments of the invention feature a method for allowing multiple, simultaneous peer connections to be established and managed between the second computing device and multiple presenters. Communications may be routed through the hardware appliance. Likewise, various users can be granted different permissions based on status. In embodiments, the first computing device may have authority to associate the hardware appliance to a user account, and designate a user associated with a computing device, privilege to connect with the hardware appliance via the unique internet address.

In yet another aspect, the invention features a method of displaying simultaneously, in a pre-calculated grid, multiple screen sharing sessions, from multiple presenters. In another aspect, the invention features a method of allowing a moderator, guest, or individual user to move, modify, and/or resize the displayed content tiles dynamically on the display screen, and to rearrange the content at will. In embodiments, moderators are also able to preview the content staged by presenters, and to control its display on the screen.

In another aspect, the invention features a method for allowing presenters to share a plurality of content from their computing device including their entire desktop, application windows or individual browser tabs. In another aspect, the invention features a method allowing presenters to stage their content inside a browser window, then push it live as needed.

In another aspect, the invention features a method to allow users to plan and schedule meetings and invite other participants to join those meetings by means of an access token. Embodiments may also feature a method of creating a composite view of the displayed content, consisting of the screen shares of a plurality of presenters, and then retransmitting this composite to a plurality of viewers, including presenters, through a secure and/or encrypted Internet connection. Presenters may also be permitted to share audio and video content including that from a connected camera and microphone, to the composite screen.

In another aspect, the invention features a method of transmitting text messages from meeting participants to the display screen in the form of notes that may be expanded, read, hidden and deleted by a moderator. Various embodiments further comprise a method of multi-layered, on-screen annotation that allows presenters to mark up their own content, and in some cases, while allowing a moderator to place markups over top of all content. Markups may then be saved as part of recording the meeting session.

It will be appreciated that the present invention is not limited to the above embodiments and examples, and various combinations and sub-combinations of these exemplary embodiments may be accomplished and are within the scope of the invention described herein, and with respect to additional inventive features and aspects described below.

### BRIEF DESCRIPTION OF THE DRAWINGS

FIG. 1 is a block diagram of a system for facilitating connections between computing devices, in accordance with embodiments discussed herein.

FIG. 2 is a block diagram of a hardware processor in accordance with embodiments discussed herein.

FIG. 3 is a block diagram of a Client Connection Logic in accordance with embodiments discussed herein.

FIG. 4 is a block diagram of a User Web Interface in accordance with embodiments discussed herein.

FIG. 5 is a block diagram of Content Staging Controls in accordance with embodiments discussed herein.

FIG. 6 is a block diagram of User Content Controls in accordance with embodiments discussed herein.

FIG. 7 is a block diagram of a User Content Control Detail in accordance with embodiments discussed herein.

FIG. 8 is a computing environment in accordance with embodiments discussed herein.

### DETAILED DESCRIPTION OF ILLUSTRATIVE EMBODIMENTS

The inventive system, which may be referred to herein as KLIK Boks KORE, is an integrated hardware/software solution for collaboration. Systems and embodiments allow users to share content from any device to a central screen and in turn back to other users' screens for remote viewing of the content. Content displayed on the central screen can be tiled in a grid by default, but may be resized, moved and overlaid in any arrangement by a meeting moderator, either by mouse or touch display control. Content may be annotated by those sharing, or by the moderator, directly over each tile, or across the entire screen surface.

Features of the inventive system may include an Ultra High-Definition (UHD), 4K Screen Sharing and Collaboration system, supporting 2 Video Displays, and a full-motion screen sharing from any device, using only a compatible browser. Embodiments may comprise an unlimited number of concurrent users and live streams can be accommodated. Users can view the composite image on their own devices in real time. In other embodiments, a composite view displays shared content from a designated computing device, or content from each computing device, or a selected plurality of computing devices. Moreover, the displayed content can be dynamically moved and/or resized on the visual interface, by individual users, or a designated user, which could cause dynamic resizing on each user's display.

Embodiments comprise a network-independent design requires only an Internet connection, including LTE and cellular networks.

During operation, users can share a plurality of content, including but not limited to applications, Browser Tabs, Desktop content, audio and visual data, e.g., from a camera, microphone, or other peripheral.

Content streams are replicated on the screen in dynamically resizable tiles and may be customized by one or more users. For example, a moderator mode can allow on-screen thumbnail preview and selection of streams. Multi-layer Annotation features can permit multiple, individual user annotations and overall Moderator annotations.

A built-in messaging system may be incorporated, allowing an on-screen cache of user messages that can hidden, deleted, saved, edited, and so forth. In embodiments, a HID back-channel can permits control of streaming PCs through touch displays or shared keyboard/mouse. Moreover, embodiments may be optimized for touch displays with gesture support to pinch and stretch for image zoom and movement.

Systems, methods, and embodiments can additionally support scheduled meetings through secure invitation tokens, password-protected, password-restricted, or other privacy and encryption means preventing others from joining. Further, systems, methods, and embodiments can support Impromptu Meetings, with or without passcode access restriction. Advanced session Recording features may capture all content, annotations and messaging, locally or centrally. A cloud-based Central Management System is utilized in embodiments for features including but not limited to device, user and session management, connection, and event logging.

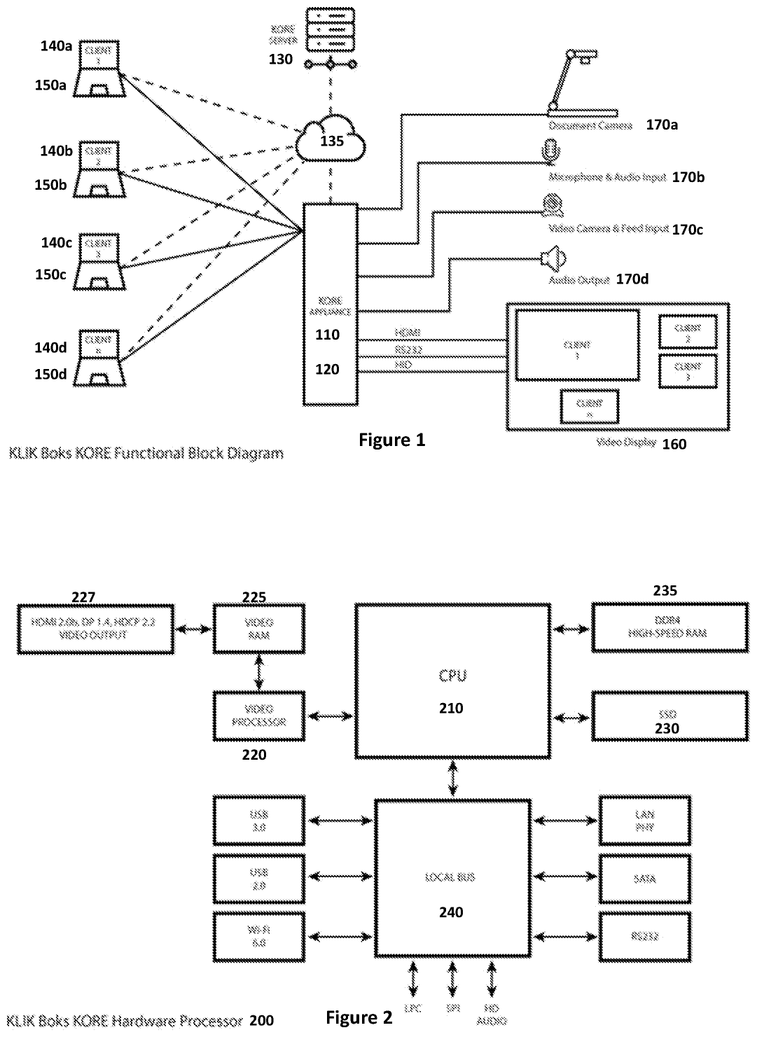

FIG. 1 is a functional block diagram of an exemplary system in accordance with embodiments. The system comprises five key components: (i) the hardware appliance 110; (ii) the software application 120; (iii) the cloud-hosted server 130; (iv) users' computing devices 140a-d; and (v) the respective web browsers 150a-d running on each user's device. As shown, the appliance 110 may be coupled to a video display 160 and other devices and peripherals 170a-d, including a document camera, microphone, video camera, and audio output (e.g., speaker). The hardware appliance 110 can acts as host for the software application 120, and the hardware interface between the local display screen and other peripherals. Hardware appliances 110 are scalable and may contain more or less processing power as determined by the application and defined features.

In embodiments, on first start, the appliance 110 attempts to reach the server 130, e.g., over the Internet 135, in order to carry out an authentication process. Once authenticated, the 110 appliance maintains a secure connection, such as a Web Socket connection, with the server 130. In embodiments, the server 130 may be a cloud server, and may be hosted over one or more local or remote networks.

A plurality of users—Client 1, 2, [. . . ], n—can connect to the hardware appliance 110. Users be categorized as Owners, Registered Users or Guest Users. Users designated as “Owners” have the authority to authenticate a new appliance 110 to their account, and in turn designate other users as Registered Users or Guest Users, and grant privileges. During authentication, the Owner can assign a name and identity to the appliance 110, as well as a web uniform resource locator (URL) following a prescribed pattern provided by the server. Users will then be able to identify and connect with the appliance 110 by entering this URL into the address field of a compatible web browser.

The custom URL does not include the actual, physical URL of the appliance 110 itself. The actual address of the hardware appliance is stored on the secure server 130, which translates the inbound URL request in order to relay the message to the hardware appliance 110. Accordingly, a user may initiate a session with the appliance 110 only through the server 130, by first signaling their intent to establish a streaming session. Depending on the class of user, their relationship to the specific device and permissions settings established by the Owner, the appliance 110 may initiate the connection process.

Accordingly, once connection is established with each of the Client devices, a video display 160 comprising shared content from the users can be displayed. In embodiments, the video display may be connected to the hardware appliance 110, via one or more hardware and/or or software connections. For example, the video display may be connected via an HDMI cable, RS232 cable, HID cable or other means. The video content can display content, e.g., from a video camera or a shared screen from the Clients 1-n, connected to the appliance 110. Likewise, on each client device 140a-d, the web browser through which the client device connects to the appliance 110 can display the same content as on video display 160.

A connection between the user and the device is initiated through the encoded relay between the server and both end-points of their relative Internet addresses and network address translation data required to successfully traverse gateways between the peers. If the user is authenticated, the session will begin between that user and the appliance 110, permitting bi-directional communication using standard web signaling and communication protocols.

FIG. 2 is a block diagram of an Appliance's Hardware Processor 200. Disclosed systems and embodiments require a dedicated hardware end-point to perform several critical functions required to deliver the stated feature set. This hardware end-point comprises a central processing unit (CPU) 210 and graphics processing unit (GPU) 220 that together manage all of the data processing and video rendering that is subsequently output to an external video display. The GPU 220 can further comprises video RAM 225 and be connected to a video output 227, such as a HDMI 2.0b, DP 1.4, HDCP 2.2 video output.

The end-point device 200 contains a solid-state drive (SSD) 230 that can host the operating system (OS) and the application 110 and employ high-speed random-access memory (RAM) 235 in which computations are executed in real time. The CPU 210 may be coupled to a Local Bus 240 as shown.

The end-point device 200 can contain a minimum of two network interfaces, one for wired Ethernet (IEEE 802.3) connections and the second for wireless, Wi-Fi (IEEE 802.11x) connections. Each of the network connections employs a media access control (MAC) address, that is globally unique to that device and is used in the identification of the device to the server. The MAC address of each interface is translated by an algorithm into a string of alpha-numeric characters that acts as a hash of the actual address. This hash may be used to authenticate the hardware to the remote server at setup, and in all subsequent communications.

The processing device contains a variety of serial interfaces including universal serial bus (USB) 2.0, USB 3.0, Serial ATA (SATA), LAN PHY, and RS232 for direct interface to external devices for the purposes of data interchange, control and monitoring. Through the installation of appropriate software drivers, the device can accommodate the connection of video cameras, document cameras, audio devices such as microphones and speakers, as well as human interface device (HID) components such as pointing devices, touch screens and keyboards. Likewise, the serial interfaces may be employed to receive or relay control commands from or to external devices such as video displays, lighting controllers, audio and video systems and peripherals and environmental sensors and indicators.

The Hardware Processor 200 is configured in embodiments to perform the following functions: hosting the software application 120; making a persistent connection, e.g., WebSocket connection, to the server; communicating with the LAN; accepting control input from HID and Touch devices; rendering video and audio from the data streams; and connecting peripheral imaging devices such as cameras.

Moreover, the software application 120 can perform the following functions, among others: initiating and creating the persistent WebSocket connection; launching the device user interface (UI); facilitating all of the I/O and peripherals; and calling the server 130 to initiate the verification process.

The Server 130 can is configured in embodiments to perform the following functions, among others: storing all of the setup information for devices, users and sessions; monitoring alive status of connected appliances; and facilitating peer-to-peer connections between authenticated Users and the Hardware Processor.

The Client Computing Device 140 is configured to perform the following functions: hosting the Web Browser used to connect with the server 130; hosting content that will be shared with the appliance 110; hosting a camera, microphone, display screen and speakers; providing the HID control over the sharing page, e.g., webpage. A web browser 150, acting on client computing devices can perform the following functions: acting as the user interface, and capturing the screen and audio.

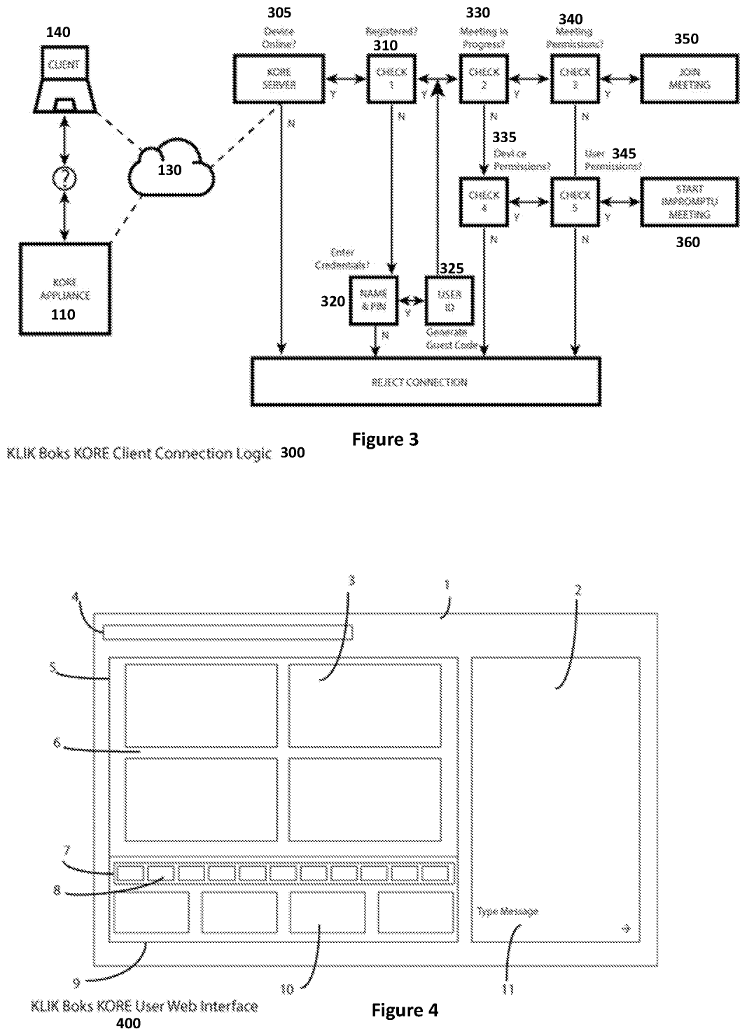

FIG. 3 is a block diagram of the Client Connection Logic 300, executed by the server 130, in accordance with embodiments. The server 130 receives and validates user credentials and compares their permissions to those established for Users, Sessions and Devices, before accepting or rejecting the user's request to join or initiate a session. In embodiments, credentials may comprise at least one of a username, a password, an access token, a unique meeting code, a device identifier, and a PIN.

[symbol]

In a first situation, the user has never before connected to the hardware appliance 110 through the validation process, and no peer-to-peer connection is initiated. The Server 130 can maintain a persistent Web Socket connection with the hardware appliance 110, constantly monitoring it online status.

The connection logic first determines if the hardware device 110 is online 305. If the KORE device 110 is not online, the connection is automatically rejected. If the KORE device 110 is online, the Kore Server 130 will perform Check 1, 310 to check the User's registration status. Registered Users are prompted to log in, e.g., by a user name and password, and in doing so, can auto-populate their identity card, provide them with access to assigned privileges, and move onto Check 2, 330. Users who are not registered are prompted to enter their name and access token, e.g., a PIN, which can be generated by the hardware appliance 110 and disseminated by the session organizer for that specific session. Upon presentation of the access token, the user is granted a temporary User ID which confers the predetermined set of permissions to the Guest, and the logic moves on to Check 2. Users who cannot validate their participation with a valid token, such as a name and pin number, are denied access.

Sessions are governed by permissions that may be assigned by the Owner, Moderator or system-wide by policy. Session access may be restricted by individual User, by Class, and by Lock Status, for example. Any session or neetung may be locked to further participants after it has started, i.e., based on a meeting time, or an operational mode, e.g., switched to Moderated operation, allowing the Moderator to limit access by individual user. Device Permissions may be set to allow or forbid access to individual Users, by Class, and by Lock Status.

As the user credentials are verified as Registered or Guest (Check 1, 310), the connection logic 300 can then determine whether a meeting is currently in progress (Check 2, 330). If a meeting is in progress, the Meeting Permissions 340 are determined. If the Meeting Permissions are valid, the User can Join Meeting 350. If the Meeting Permissions are not valid, the User Permissions 345 are determined, as discussed herein.

Returning back to Check 2, 330, if a meeting is not in progress, the connection logic looks at the Device Permissions 335. If the device does not have credible Device Permissions, the connection is rejected. If the Device Permissions are valid, User Permissions are checked 345. Valid User Permissions 345 allow the user to Start an Impromptu Meeting 360, and invalid User Permissions cause a rejection of the connection.

Device Permissions may include one or more determinations to identify whether the device is allowed to connect. Considerations for Device Permissions may include a type of hardware requesting to join access, a determination as to whether the device is on a list for access or blocks, and other determinations, as determined by particular system and user considerations. Meeting Permissions may be defined, in embodiments, by the Meeting Organizer, Owner of the device 110, or other device or user having access to define meeting, users, devices, and other aspects of the meeting. User Permissions can be similarly determined, by default, Owner, Meeting Organizer, etc., and can define which users are allowed access to the meeting. Allowed users can be defined by particular users, organizers, stored groups, etc., and/or have a particular identity, required passcode, PIN, encryption setting, and any of a plurality of settings that can be adapted and modified based on particular system and/or user requirements.

FIG. 4 is a diagram an example User Web Interface 400 that can be used in embodiments. Once a session is established between a user and the hardware appliance 110, the user may be provided a web page directly from the hardware appliance 110. All further interaction between the user and the appliance is on a peer-to-peer basis, with no content being shared with the server 130. The server receives communications from users and the hardware appliance 110, only as needed, to report the status of the peer connections and to assist either device with connection and routing support in case of disconnection.

In embodiments, the user web interface (1) runs within the web browser on the user's computing device. The name of the connected device is displayed in an alphanumeric string on the page (4) and reflects the name assigned by the owner. The action area consists of four main areas; the Live Display (5), Control Panel (7), Staging Area (9), and Messaging Area (2).

The Live Display area (5) provides a view of all of the content currently streaming, from all users to the hardware appliance 110, including content streamed by the current user. Content is displayed in tiles (3) following the split-screen logic found on the main display screen (6), with one, four, six and nine splits. Streamed content is displayed in real time and includes superimposed annotations.

A user may initiate a stream by activating one of the buttons in the control panel to select the content they wish to stream. In the case of external devices such as cameras and microphones, or other video sources, the user may select the device directly. Contextual control will appear when settings variables are applicable. In the case of screen content, the user will select the Screen Content control (8) to invoke the Content Selector.

It will appreciated that the present invention is not limited to the depicted embodiment, and that web interfaces may comprises a variety of configurations, layouts, and designs, depending on one or more of hardware, software, user design, preferences, aesthetics, configurations, and so forth. The illustrations and embodiments set forth are but on example of an exemplary embodiment, in accordance with a plurality of designs and configurations discussed herein.

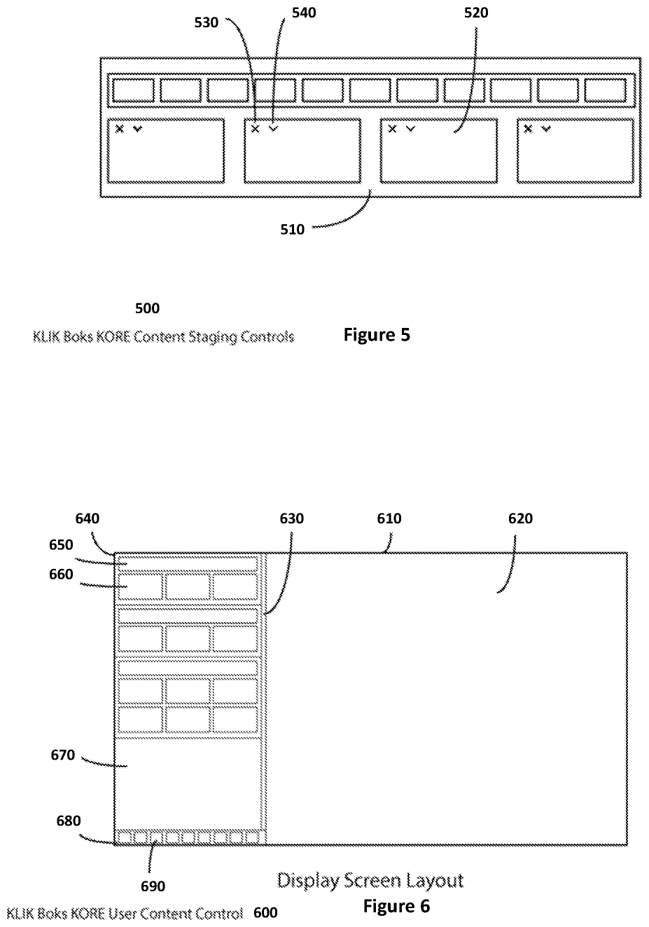

FIG. 5 is a diagram of the KORE Content Staging Controls 500. Once content is selected, it can appear in the form of a thumbnail image (10, 520) in the Staging Area (9, 510), e.g., of the user web interface. The staging area (9) provides visual feedback on the content that the user has selected to share, and may or may not be currently sharing. Staged content thumbnails are provided with two controls: (i) Start/Stop alternate-action streaming control 530, and (ii) Close the stream and remove it from the staging area 540. Once staged, the user may start streaming a content source by activating the Start/Stop control.

The user may cease streaming content, while leaving it in the staging area, by activating the Start/Stop control. Content no longer required to remain the staging area can be closed with the Close control. In embodiments, users may message other users, the moderator, and the KORE display, through the messaging interface (2). Messaging is restricted by user class, KORE appliance 110 settings, session settings and moderator settings. In embodiments, permitted users may enter a text message (11) that is then transmitted to other users and simultaneously to the KORE appliance screen for viewing by the moderator and session attendees.

FIG. 6 is a diagram of the Display Screen Layout for the KORE User Content Control 600. In embodiments, the display screen (610) consists of a standard 16:9 digital video display monitor which hosts the KORE video output at any resolution supported by the monitor. The display area (620) is the area on the display monitor that the image output from the KORE device will populate with content. Moderator control over the session is administered through a plurality of controls located in a dismissible overlay to the display area (670). The Moderator may call up the control panel through a HID input instance, in which case it will be displayed. The overlay will be automatically dismissed by means of a variable timer, within a prescribed time period, if no interaction is sensed. HID interaction will reset the timer, extending the displayed time of the control panel.

The control panel displays connected User Name (650) and thumbnail images of User Content (660), contained within an individual User Block (640). User names are derived from the database for registered users, and from the identification input field for Guest Users. Content that is currently being shared by the user is displayed in a series of tiles ordered from left to right, for the width of the control panel, then continuing to a new row, by expanding the container allocated to the individual user. An unlimited number of containers, containing an unlimited number of tiles, on an unlimited number of rows may be accommodated. A scroll bar (630) appears when the amount of information to be display exceeds the available vertical area of the control panel.

An area within the control panel (680) is reserved for moderator controls over a variety of functions. Each function is allocated an icon (690) that represents a clickable touchpoint for control over that function. Control functions are displayed contextually, based on the operating mode of the device at the time, and not all control inputs are displayed at one time.

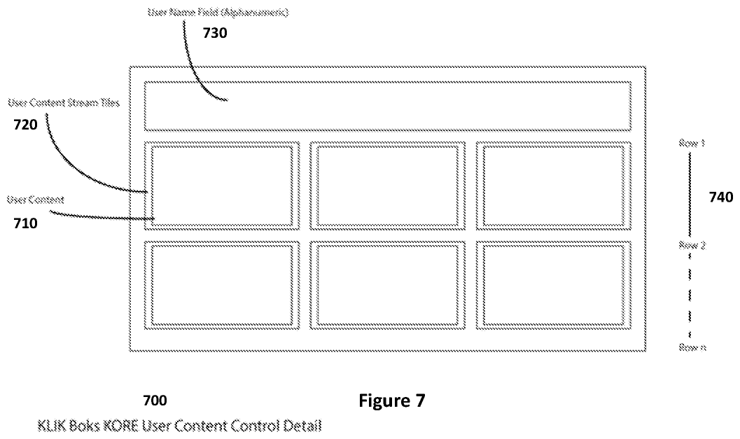

FIG. 7 is a diagram of the KORE User Content Control 700. Each User Block consists of a single User Name field 730 and a plurality of User Content Tiles 720, with one tile for each active stream (or share) from that individual user. User Content Stream Tiles 720 are sized larger than the actual content stream thumbnails displaying User Content 710 and are filled with contrasting colors to indicate the state of the stream. One color can be displayed around the perimeter of the thumbnail to indicate that the stream is shared by the user, but not yet enabled to the display screen. A second, contrasting color is displayed to indicate that the shared stream is currently being displayed on the display screen. In use, the moderator will open the control panel though a HID event, in order to view the (1) connected users by name, (2) content currently being shared by those users, and (3) the state of the shared content with respect to the display. There can be n-number of rows 740 of User Content Stream Tiles 720, e.g., depending on a total number of users.

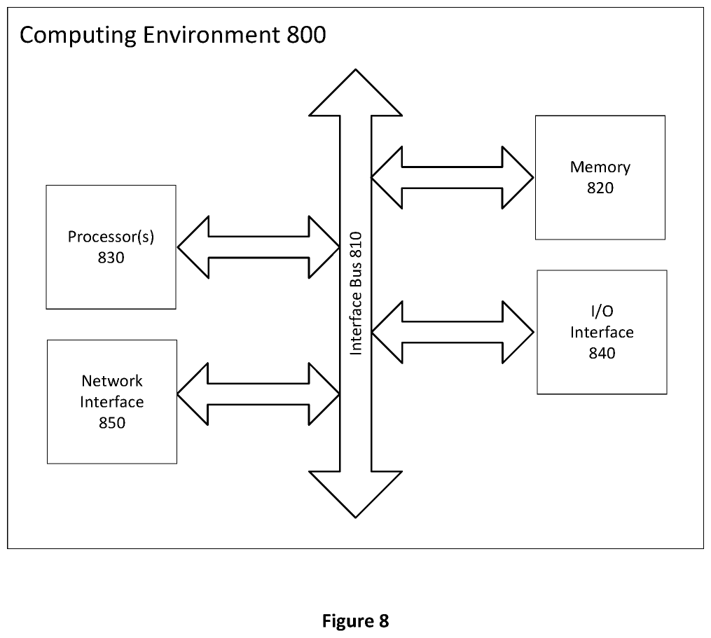

FIG. 8 illustrates an example computing environment 800 in which embodiments of the present invention may be utilized on with. As utilized herein, the phrase “computing system” generally refers to a dedicated computing device with processing power and storage memory, which supports operating software that underlies the execution of software, applications, and computer programs thereon. As used herein, an application is a small in storage size, specialized program that is downloaded to the computing system or device. In some cases, the application is downloaded from an “App Store” such as APPLE's APP STORE or GOOGLE's ANDROID MARKET. After download, the application is generally installed on the computer system or computing device. As shown by FIG. 8, computing environment 800 includes bus 810 that directly or indirectly couples the following components: memory 820, one or more processors 830, I/O interface 840, and network interface 850. Bus 810 is configured to communicate, transmit, and transfer data, controls, and commands between the various components of computing environment 800.

Computing environment 800 typically includes a variety of computer-readable media. Computer-readable media can be any available media that is accessible by computing environment 800 and includes both volatile and nonvolatile media, removable and non-removable media. Computer-readable media may comprise both computer storage media and communication media. Computer storage media does not comprise, and in fact explicitly excludes, signals per se.

Computer storage media includes volatile and nonvolatile, removable and non-removable, tangible and non-transient media, implemented in any method or technology for storage of information such as computer-readable instructions, data structures, program modules or other data. Computer storage media includes RAM; ROM; EE-PROM; flash memory or other memory technology; CD-ROMs; DVDs or other optical disk storage; magnetic cassettes, magnetic tape, magnetic disk storage or other magnetic storage devices; or other mediums or computer storage devices which can be used to store the desired information and which can be accessed by computing environment 800.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, communication media includes wired media, such as a wired network or direct-wired connection, and wireless media, such as acoustic, RF, infrared and other wireless media. Combinations of any of the above should also be included within the scope of computer-readable media.

Memory 820 includes computer-storage media in the form of volatile and/or nonvolatile memory. The memory may be removable, non-removable, or a combination thereof. Memory 820 may be implemented using hardware devices such as solid-state memory, hard drives, optical-disc drives, and the like. Computing environment 800 also includes one or more processors 830 that read data from various entities such as memory 820, I/O interface 840, and network interface 850.

I/O interface 840 enables computing environment 800 to communicate with different input devices and output devices. Examples of input devices include a keyboard, a pointing device, a touchpad, a touchscreen, a scanner, a microphone, a joystick, and the like. Examples of output devices include a display device, an audio device (e.g. speakers), a printer, and the like. These and other I/O devices are often connected to processor 810 through a serial port interface that is coupled to the system bus, but may be connected by other interfaces, such as a parallel port, game port, or universal serial bus (USB). A display device can also be connected to the system bus via an interface, such as a video adapter which can be part of, or connected to, a graphics processor unit. I/O interface 840 is configured to coordinate I/O traffic between memory 820, the one or more processors 830, network interface 850, and any combination of input devices and/or output devices.

Network interface 850 enables computing environment 800 to exchange data with other computing devices (e.g., Clients 1-n, and server 130) via any suitable network (e.g., network, Internet, etc.). In a networked environment, program modules depicted relative to computing environment 800, or portions thereof, may be stored in a remote memory storage device accessible via network interface 850. It will be appreciated that the network connections shown are exemplary and other means of establishing a communications link between the computers may be used.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

The present invention also relates to an apparatus or system for performing the operations described herein. This apparatus or system may be specifically constructed for the required purposes, or the apparatus or system can comprise a general-purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general-purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

What is claimed:

1. A system for facilitating a peer-to-peer connection between a plurality of computing devices, comprising:
a remote server configured to authenticate and manage connections between computing devices;
a visual interface for displaying shared content over a web browser;
a hardware appliance in network communication with the remote server, the hardware appliance comprising a processor and a memory having instructions stored thereon to execute a software application causing the hardware appliance to at least:
receive a request from a first computing device to initiate a meeting to display shared content;
establish a secure connection with the remote server;
generate a unique internet address through which to display shared content;
receive an indication of a request at the unique internet address, from a second computing device, to join the meeting, wherein the request includes credentials from the second device;
authenticate the credentials at the remote server; and
display shared content via the visual interface, on the first computing device and the second computing device.

2. The system of claim 1, wherein the instructions causing the hardware display to display shared content further comprise:
receiving content from each computing device at the meeting, the content comprising at least one of audio and visual content;
compiling the content from each computing device into a composite view comprising thumbnails displaying content from each computing device; and
displaying the composite view on a display of each computing device.

3. The system of claim 2, wherein the content is at least one of: a live video, a screen share, an image, and an input from a peripheral device.

4. The system of claim 3, wherein the peripheral device is at least one of a microphone, a video camera, a document camera, and an audio output.

5. The system of claim 2, wherein the composite view is dynamically modifiable at each computing device.

6. The system of claim 1, wherein the shared content comprises at least one of: a desktop, an application window, a browser tab, a screen share, a portion of a display, input from a peripheral, and a user-selected portion of a display.

7. The system of claim 1, wherein the server is a cloud server, hosted over one or more local or remote networks.

8. The system of claim 1, wherein the credentials comprise at least one of a username, a password, an access token, a unique meeting code, a device identifier, and a PIN.

9. The system of claim 1, wherein communications between the hardware appliance and the remote server are encrypted.

10. The system of claim 1, wherein the remote server manages user authentication, session management, and event logging for a plurality of hardware appliances.

11. A method for facilitating connections between a plurality of computing devices, comprising:
establishing a secure connection between a remote server and a hardware appliance comprising a processor and a memory;
at the hardware appliance, receiving a request from a first computing device to initiate a meeting to display shared content and generating a unique internet address through which to display the shared content;
authenticate the credentials at the remote server; and
display shared content via a common visual interface displayed on the first computing device and the second computing device.

12. The method of claim 11, further comprising granting the first computing device authority to associate the hardware appliance to a user account, and designate a user associated with a computing device, privilege to connect with the hardware appliance via the unique internet address.

13. The method of claim 11, wherein all communication between the first computing device and second computing device is routed through the hardware appliance.

14. The method of claim 11, wherein the common visual interface displays a composite view of shared content from each computing device in the meeting.

15. The method of claim 11, wherein the common visual interface displays a composite view of shared content from a designated computing device in the meeting.

16. The method of claim 11, further comprising, at each computing device, dynamically moving and/or resizing displayed content on the common visual interface.

17. The method of claim 11, wherein the shared content comprises at least one of: a desktop, an application window, a browser tab, a screen share, a portion of a display, input from a peripheral, and a user-selected portion of a display.

18. The method of claim 11, wherein the credentials comprise at least one of a username, a password, an access token, a unique meeting code, a device identifier, and a PIN.

19. The method of claim 11, wherein authentication is restricted based on user name, user type, a meeting start time, lock status, device permissions, user permissions, and meeting permissions.

20. The method of claim 11, wherein the common visual interface is displayed via a web browser.
